(19) United States
(12) Patent Application Publication
(10) Pub. No.: US 2005/0193654 A1
(43) Pub. Date: Sep. 8, 2005

(54) Devices, systems and methods for manufacturing and installing modular window trim

(76) Inventor: Jon R. Primozich, Burlington, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/969,370

(22) Filed: Oct. 19, 2004

Related U.S. Application Data
(60) Provisional application No. 60/544,879, filed on Feb. 13, 2004.

(51) Int. Cl. E06B 3/00; E06B 1/04; B60J 1/16; E05F 11/38

(52) U.S. Cl. 52/204.5

(57) ABSTRACT

The present invention is directed toward apparatus and methods for aligning and retaining a modular window trim assembly to an interior side of a wall opening. Embodiments of the invention incorporate a surround portion and a casing portion, and use an opposing pair of biased clip members to retain the trim assembly in the window opening and to automatically center the trim assembly therein. The biased clip members can be adapted to facilitate installation of the trim assembly and/or resist removal of the trim assembly from the window opening.

### BACKGROUND OF THE INVENTION

1. Field of the Invention

The present invention relates to window trim and, more specifically, to modular window trim and methods for making and installing the same.

2. Description of the Related Art

The height, width and thickness of a window frame are usually less than the corresponding dimensions of the rough window opening. These differences result in gaps that are commonly masked by window trim.

With conventional window trimming methods, boards are each individually cut and fastened to the inner wall opening to surround the window. To further enhance the overall look of the window, the interior walls surrounding the window are often cased with a decorative trim. All of these steps are usually done at the place where the window is being installed.

### BRIEF SUMMARY OF THE INVENTION

The present invention is directed toward devices, systems and methods to align and retain a modular window trim assembly within a wall opening.

In one particular embodiment, a modular window trim system simultaneously cases and decoratively finishes an interior side of a window opening in a wall. The trim system incorporates a unitary trim assembly having a surround portion configured to complement the window opening and a finishing portion that is positionable against the wall. At least one pair of biasing members are postionable on opposing sides of the trim assembly and aligned to facilitate insertion of the trim assembly into the window opening while resisting removal therefrom. The biasing members are oriented to produce substantially equal and opposing biasing forces between the trim assembly and the window opening when the trim assembly is in the installed positioned, and thereby automatically center the trim assembly within the window opening,

In another particular embodiment, a method aligns and retains a modular window trim assembly within a window opening. A first biasing member is coupled to a first location on the trim assembly and a second biasing member is coupled to a second location on the trim assembly that is substantially opposite to the first location. When the trim assembly is inserted and released into the wall opening, the opposing biasing members automatically center the trim within the window opening.

### DESCRIPTION OF THE FIGURES

FIG. 1 is an elevation view of a modular trim system according to an embodiment of the present invention;

FIG. 2 is a cross-sectional view of a portion of the modular window trim system of FIG. 1, as seen along Section 2-2;

FIG. 3 is a cross-sectional view of a portion of the modular window trim system of FIG. 1, as seen along Section 3-3;

FIG. 4 is a cross-sectional view of a portion of the modular window trim system of FIG. 1, as seen along Section 4-4;

FIG. 5 is an isometric view of a modular window trim system according to another embodiment of the present invention;

FIG. 6 is an exploded view of a modular window trim system of yet another embodiment of the present invention;

FIGS. 7A and 7B are assembly drawings showing an embodiment of the system being installed;

FIGS. 8A and 8B are assembly drawings showing another embodiment of the system being installed;

FIGS. 9-16 show various embodiments of biasing members according to the present invention; and

FIGS. 17-20 show various architectural types of trim according to the present invention.

### DETAILED DESCRIPTION OF THE INVENTION

The present detailed description is directed toward embodiments of a system and method for aligning and retaining a modular window trim assembly 10 within a wall opening.

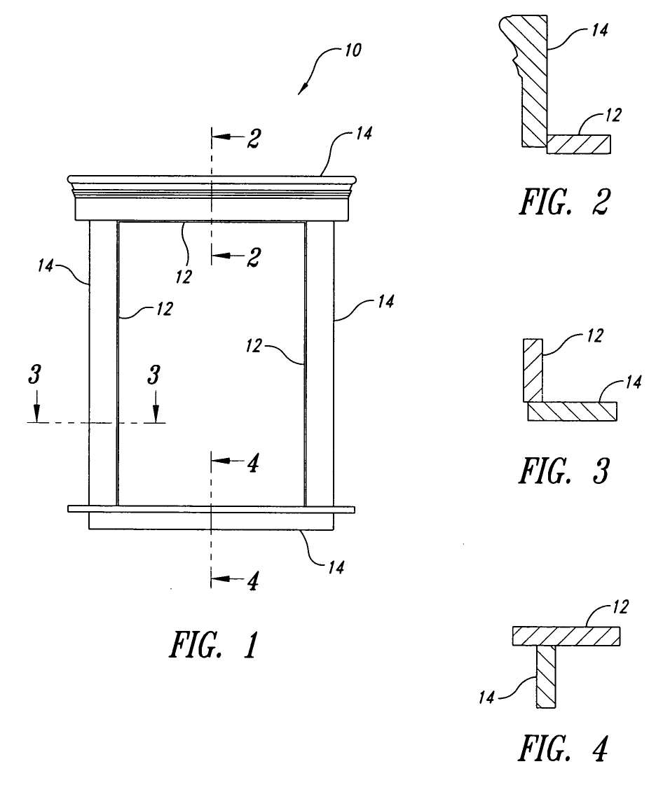

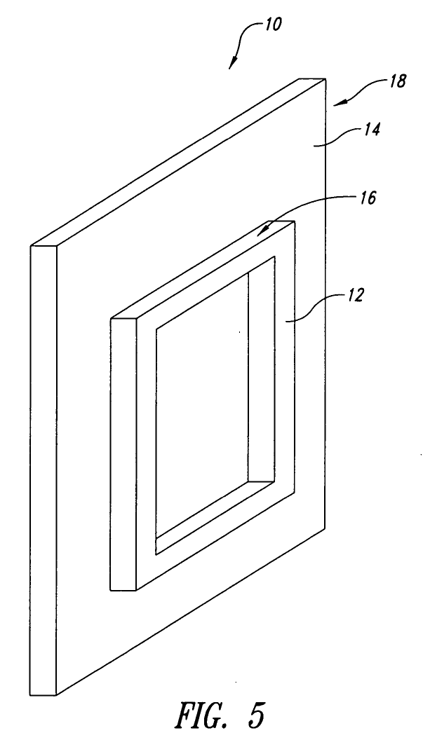

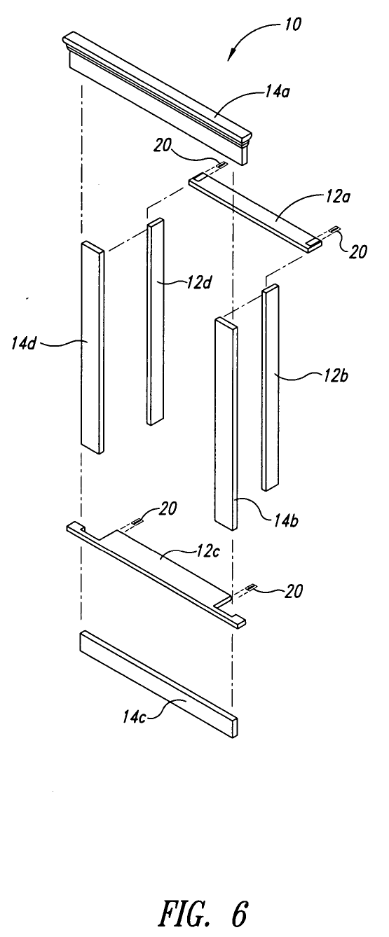

FIGS. 1-4 show one embodiment of the modular trim assembly 10 having a surround 12 coupled to a casing 14. FIG. 5 shows that the surround 12 and the casing 14 can be a single, monolithic assembly 18. Alternatively, the surround 12 can be constructed from a plurality of elements, such as those identified in FIG. 6 by reference numbers 12a-12d. Similarly, the casing 14 can be constructed of a number of pieces, such as those identified in FIG. 6 by reference numbers 14a-14d.

The modular window trim assembly 10 can be made of wood, composite material, plastic, or another suitable material. The surround 12 can be fixed to the casing 14 using a number of means, such as nails, screws, fasteners, glue, epoxy, and other equivalents thereof.

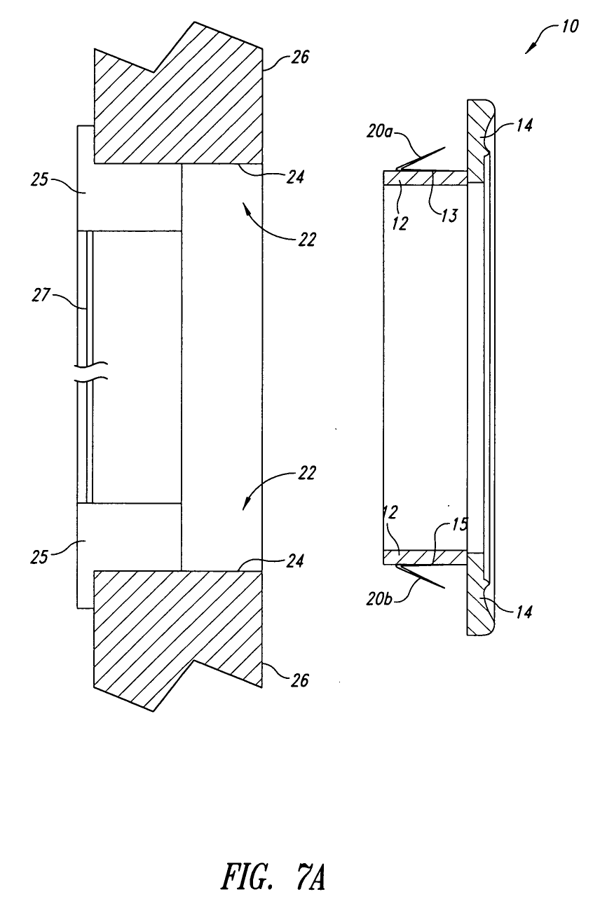

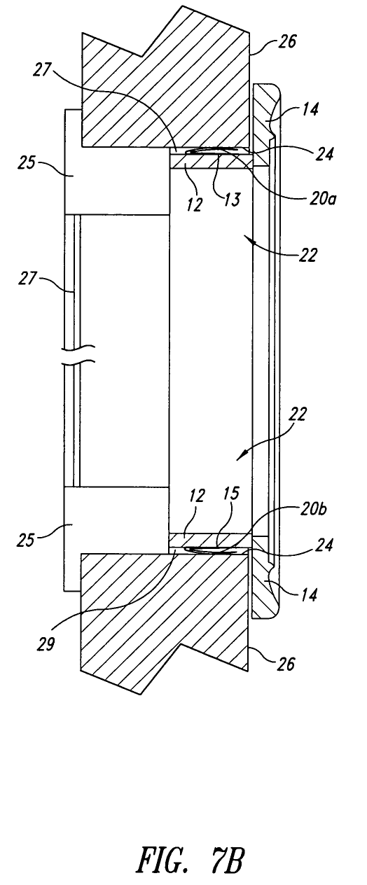

FIG. 6 shows an embodiment of the modular window trim assembly 10 having biasing members 20 positioned at locations spaced apart from one another. In the illustrated embodiment, the biasing members 20 are coupled to top and bottom portions of the surround 12. Instead, or in addition thereto, the biasing members 20 can be coupled to side portions of the surround 12. As shown in FIG. 7A, a first biasing member 20a is coupled to a first surround member 13, and a second biasing member 20b is coupled to a second surround member 15 and is facing a direction opposite that of the first biasing member 20a. Thus, as described in more detail below, a pair of biasing members 20 works together to exert opposing forces on the modular trim assembly 10.

To help align and retain the modular window trim assembly 10 within a wall opening 22, the installer slides the surround 12 into an inner perimeter 24 of the wall opening 22. The installer urges the modular window trim assembly 10 into the wall opening 22 until one end of the surround 12 is adjacent to a window frame 25 and/or the casing 14 abuts an interior side 26 of the wall. (See FIG. 7B.)

When installed, each biasing member 20 presses against the inner perimeter 24 to retain the modular window trim assembly 10 within the wall opening 22. The trim can be further secured, if desired, with nails, caulk or other fastening means. Due to a substantially equal biasing force created by each opposingly placed biasing member 20, the present invention also automatically aligns the modular window trim assembly 10 centrally within the wall opening. This self-aligning feature is one unique advantage provided by the present invention.

Opposing biasing members 20 can apply equal and opposite force on the inner perimeter 24 of the wall opening 22. Thus, when the modular window trim assembly 10 is installed, a first distance 27 (FIG. 7B) between the inner perimeter 24 and the first surround member 13 is substantially equal to a second distance 29 between the inner perimeter and the second surround member 15.

In some cases, minor adjustments in aligning the window trim assembly 10 may be needed to account for irregularities in the wall opening 22. Such fine-tuning can be accomplished manually by moving the modular window trim assembly 10 against the biasing force and, if necessary, using fasteners or adhesives to affix the assembly 10 in the modified orientation. Fine-tuning of the final orientation of the modular window trim assembly 10 can also be accomplished by bending one or more of the biasing members 20 to either increase or reduce the biasing member's 20 restoring force. Thus, as compared to conventional means for trimming a window, the modular window trim assembly 10 of the present invention is easily centered and can obviate the need for cutting and shimming each jamb into position.

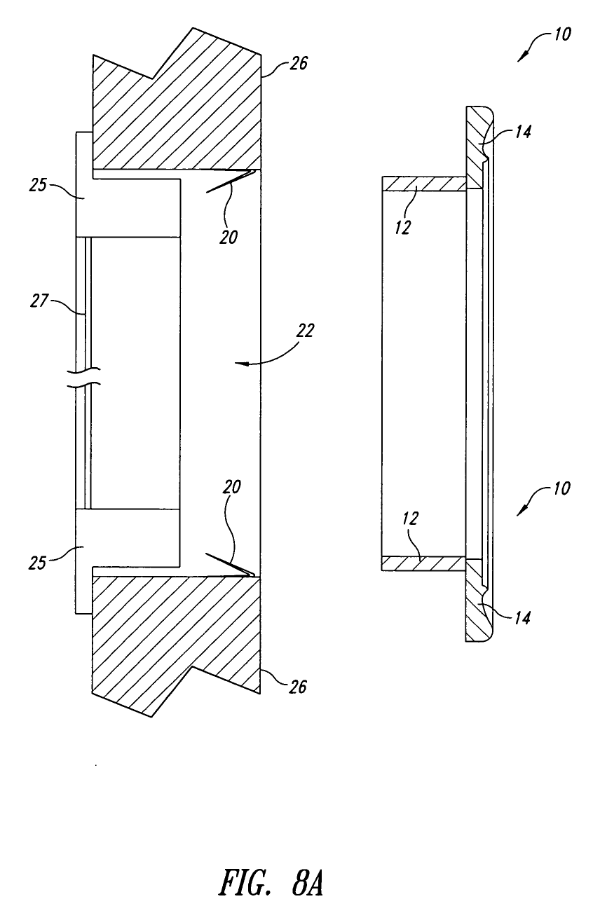

In another embodiment, shown in FIGS. 8A and 8B, the biasing members 20 are coupled to the inner perimeter 24 of the wall opening 22, instead of the surround 12. Otherwise, this embodiment aligns and retains the window trim assembly 10 to the wall opening 22 in a manner similar to that described above. As would be understood by one of ordinary skill in the art having reviewed this disclosure, the number and positioning of the biasing members 20 may be varied. The decision may be guided by factors such as the size and weight of the particular modular window trim assembly 10 being installed, the design of the particular biasing members 20, and the material of the wall opening 22.

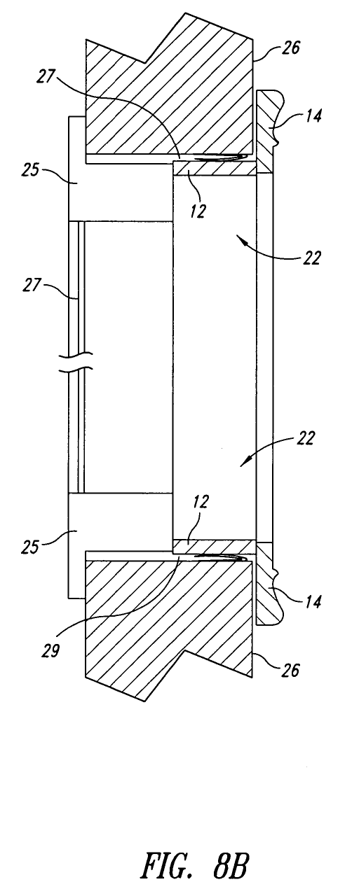

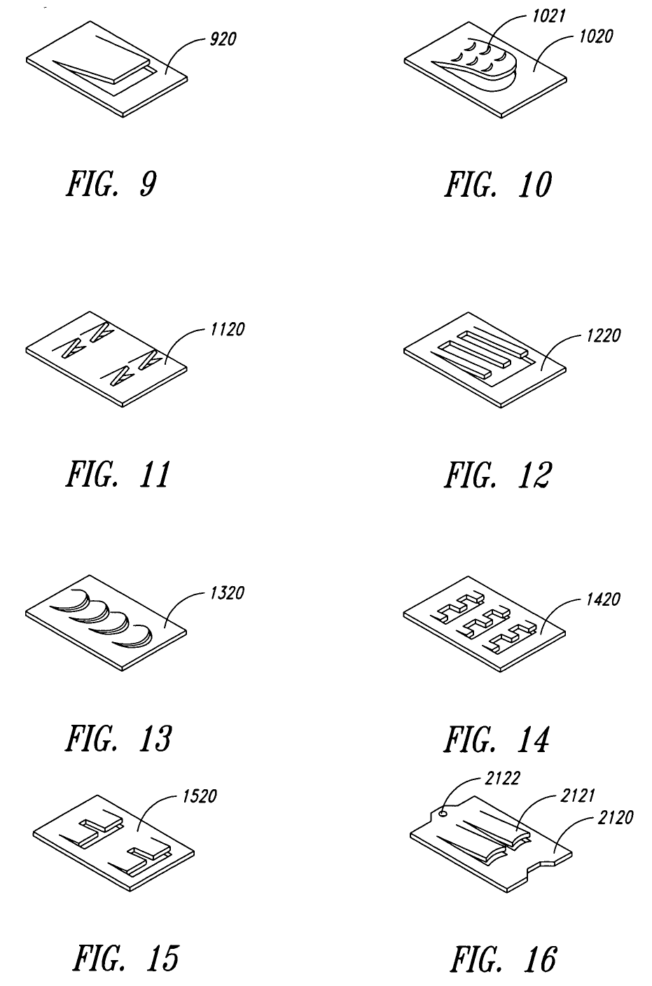

FIGS. 9-16 show various embodiments of biasing members 20. FIG. 9 shows a single, bent biasing member 920. FIG. 10 shows a single, bent biasing member 1020 having a number of retention tabs 1021, which help retain the trim within the opening. FIG. 11 shows a dual, bent biasing member 1120, having two rows. FIG. 12 shows a triple, bent biasing member 1220. FIG. 13 shows a quadruple, bent biasing member 1320. FIG. 14 shows a bent biasing member 1420 having three rows. FIG. 15 shows four bent biasing members, 1520. FIG. 21 shows a bent biasing member 2120 with compound tabs 2121 and a mounting hole 2122. The biasing members depicted in FIGS. 9-16 are example configurations and, as would be understood by one of ordinary skill in the art having reviewed this disclosure, other configurations are possible.

To affix the biasing member 20 to the modular window assembly 10 or the inner perimeter 24, double-sided adhesive or a suitable equivalent may be used. However, as would be understood by one of ordinary skill in the art having reviewed this disclosure, any number of other coupling means, such as nails, screws or glue; may be used.

The self-aligning feature discussed above is but one advantage provided by the present invention. Further advantages are provided by the ease with which a portion of the interior side 26 of the wall opening 22 is dressed. For example, in the case of a square or rectangular window, the finishing trim 14 can have a header 30, apron 32 and two side members 34, 36, and reside adjacent to the interior side 26 of the wall opening. It can have any number of aesthetic designs.

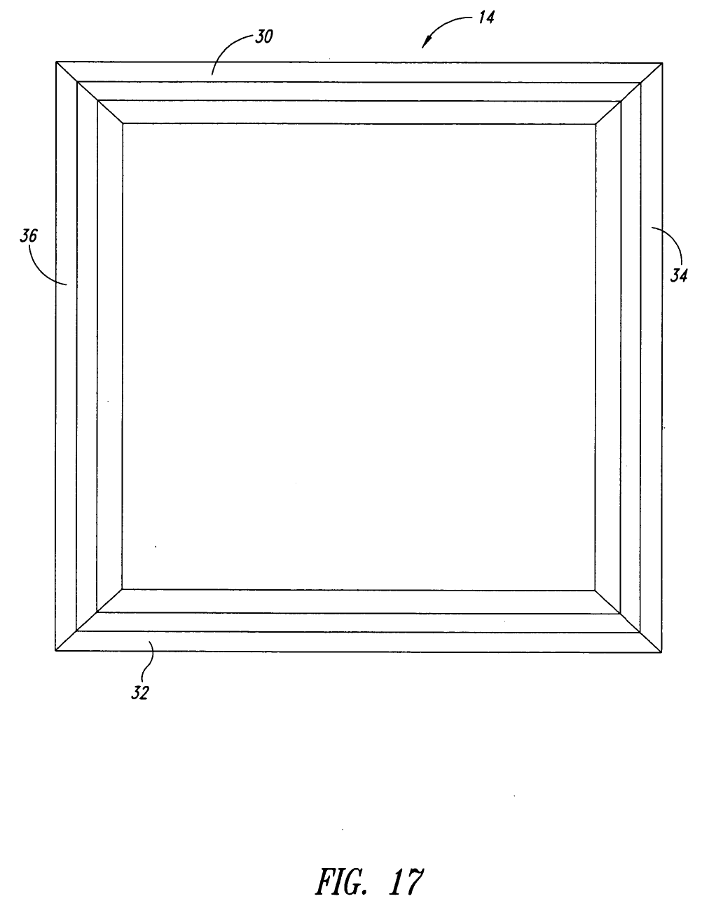

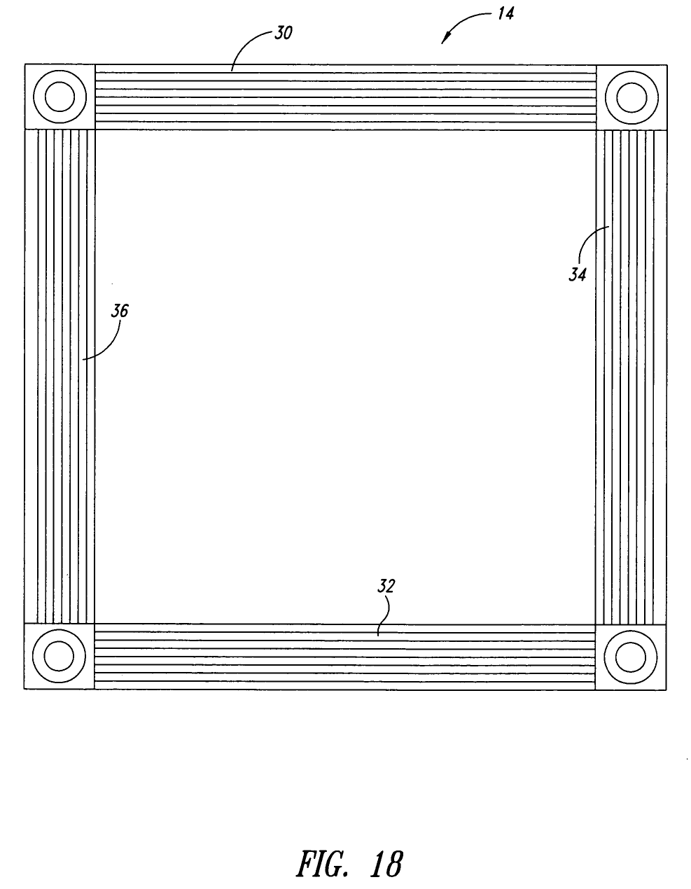

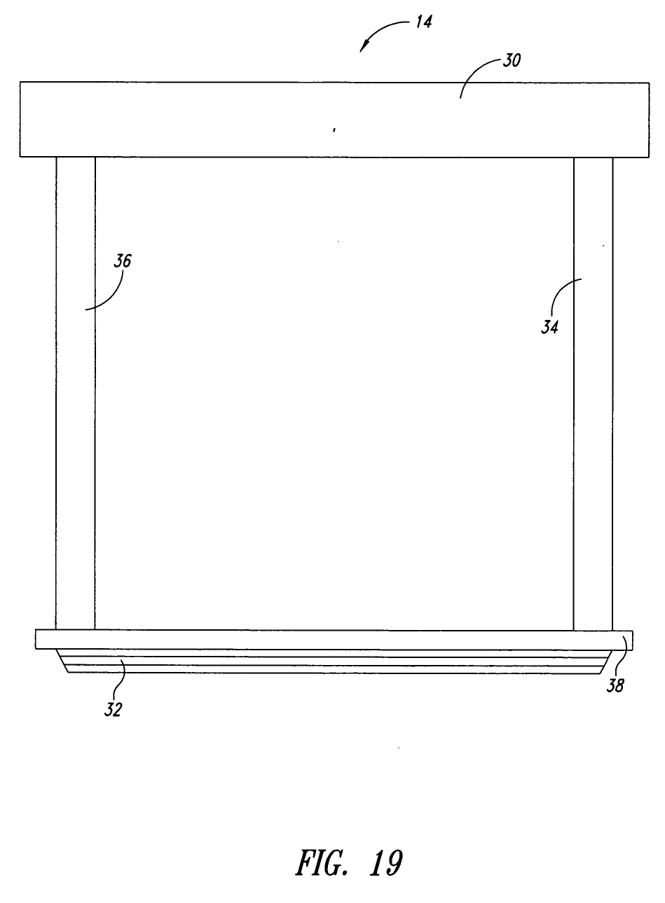

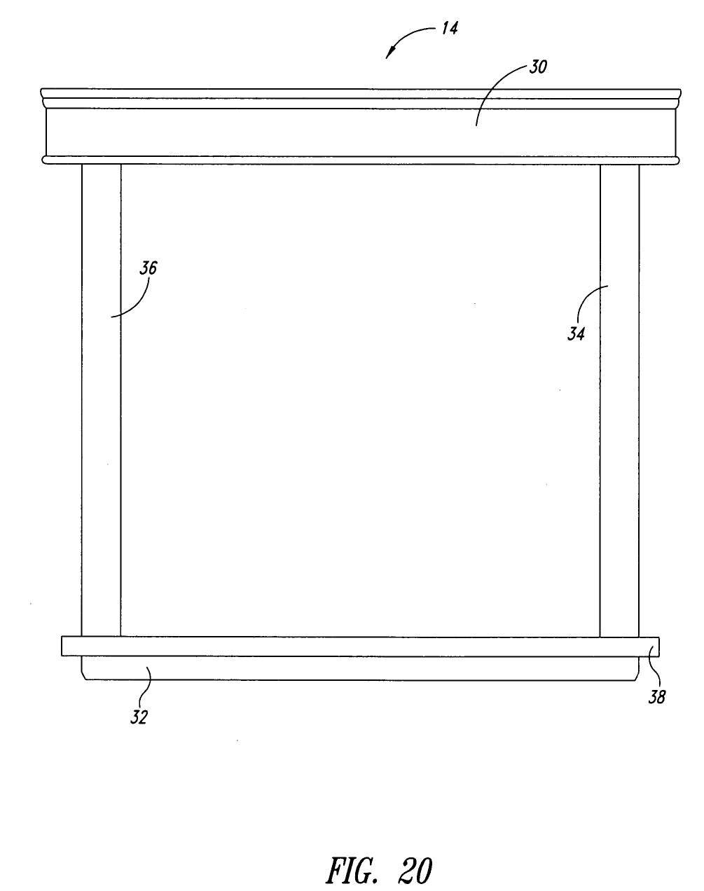

In one particular embodiment, shown in FIG. 17, the header 30, apron 32 and two side members 34, 36, each have the same design configuration. In another embodiment, shown in FIG. 18, the finishing trim 14 includes a decorative pattern at each corner. In further embodiments, shown in FIGS. 19 and 20, the finishing trim 14 includes a stool 38. Thus, the various finishing trim 14 designs dramatically dresses and enhances the interior of a window and the jamb 12, which is coupled to the finishing trim 14, serves to simultaneously produce a cased look.

As is to be understood by one of ordinary skill in the art, the finishing trim 14 of the present invention may embody any number of designs. Thus, the particular designs depicted in FIGS. 17-20 merely illustrate the various looks that can be achieved and are not to be construed as limiting the present invention.

From the foregoing it will be appreciated that, although specific embodiments of the invention have been described herein for purposes of illustration, various modifications may be made without deviating from the spirit and scope of the invention.

1. A modular window trim system for simultaneously casing and decoratively finishing an interior side of a window opening in a wall, the modular window trim system comprising:
a unitary trim assembly having a surround portion configured to complement the window opening, and a finishing portion positionable against the wall when the modular window trim assembly is in an installed position; and
at least one pair of biasing members, the biasing members being positionable on opposing sides of the trim assembly from each other and being aligned to facilitate insertion of the trim assembly into the window opening and resist removal therefrom, and the biasing members being oriented to produce substantially equal and opposing biasing forces between the trim assembly and the window opening when the trim system is in the installed positioned, whereby the trim assembly is automatically centered within the window opening.

2. The modular window trim system according to claim 1 wherein the biasing members are coupled to the trim assembly.

3. The modular window trim system according to claim 1 wherein the biasing members are coupled to the window opening.

4. The modular window trim system according to claim 1 wherein the trim assembly comprises a plurality of jambs, the plurality of jambs being coupled to one another to form a jamb assembly.

5. The modular window trim system according to claim 1 wherein the trim assembly is a monolithic unit.

6. The modular window trim system according to claim 1 wherein the finishing portion is removably coupled to the surround portion.

7. The modular window trim system according to claim 1 wherein the finishing portion is a monolithic unit.

8. A method of aligning and retaining a modular window trim assembly within a window opening, the method comprising:
coupling a first biasing member to a first location on the trim assembly;
coupling a second biasing member to a second location on the trim assembly, the second location being substantially opposite to the first location;
inserting the trim assembly into the wall opening; and
releasing the trim assembly within the wall opening so that the opposing biasing members can automatically center the trim within the window opening.

9. The method of claim 8, further comprising:
manually adjusting the alignment of the window trim assembly within the window opening and fastening the window trim in the adjusted alignment.

10. The method of claim 9 wherein the step of manually adjusting the alignment involves moving the modular window trim assembly by hand.

11. The method of claim 9 wherein the step of manually fine-tuning the alignment is provided by bending a number of the plurality of bent spring members.

12. A method of aligning and retaining a modular window trim assembly within a window opening, the method comprising:
coupling a first biasing member to a wall opening at a first location;
coupling a second biasing member to the wall opening at a second location, the second location being substantially opposite to the first location; and
inserting the trim assembly into the wall opening.
